(19) United States
(12) Patent Application Publication
(10) Pub. No.: US 2006/0096919 A1
(43) Pub. Date: May 11, 2006

(54) Apparatus/method for treating fluid

(75) Inventors: Chia-Chih Han, San Shya Town (TW); Wen-Chi Chang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Everglory Resource Technology Co., Ltd.

(21) Appl. No.: 10/984,217

(22) Filed: Nov. 9, 2004

(51) Int. Cl. C02F 3/00

(52) U.S. Cl. 210/617; 210/150

(57) ABSTRACT

An art of applying microbes to the treatment of a fluid is provided. The feature is that a large mass of microbe carriers are distributed to a plurality of containers each including a restriction structure and a fluid passage structure, wherein the restriction structure restricts the moving of the microbe carrier so that the microbe carrier is either stationary or movable in a restricted region, and the fluid passage structure provides the fluid with a flow passage between the interior and the exterior of the container so that the microbe carrier in the container contacts the fluid. Various applications based on the containers or the like are also disclosed.

### FIELD OF THE INVENTION

The present invention generally relates to application of microbe carrier in treating fluid, and particularly to apparatus including microbe carriers for treating drain water or waste liquid.

### BACKGROUND OF THE INVENTION

In conventional processes of using microbes to treat drain water, there is difficulty keeping microbes effectually reside in drain water. Although application of porous microbe carrier may extend the time period for microbes to reside in drain water, there is inconvenience and/or economical disadvantage associated with the procedures and implementations as well as maintenance thereof. It is extremely difficult to have a large mass of microbe carriers evenly dispersed in the drain water to be treated, and it is even unrealistic or impractical to control the location of each of the microbe carriers or the distribution of the large mass of microbe carriers in a realizable and economic way. For example, a large mass of microbe carriers poured into or sprinkled onto the drain water will always accumulate on the bottom of the storage facilities accommodating the drain water, or on the location through which the drain water flows out of the storage facilities in case there is need of in-and-out flowing of the drain water. The mass of microbe carriers, unevenly dispersed, always tend to excessively accumulate on one or few positions in the storage facilities, with biofilms of the microbes forming a hindrance to the flowing of water, and lowering the efficiency of treating the drain water. Even if the mass of biofilms of the microbes may be cleaned by applying inversely flowing water to the microbe carriers, the scheme is feasible only for a temporary purpose, and far away from providing a permanent or an ideal solution, not to mention the significant cost (temporary treatment process delay and need of extra labor as well as extra facilities) arising therefrom. It can thus be seen that the best solution to the problem is to have the mass of microbe carriers evenly dispersed or controlled to evenly spread in the drain water to be treated, thereby any undesired accumulation of the microbe carriers can be prevented or easily amended.

In conventional processes of using microbe carriers (such as Plastic Pall Rings, Activated Carbon, Filter Media or Contact Filter in Bio-Filtration) to treat drain water, microbe carriers are usually fixed in stationary states or placed in floating states. The microbe carriers, fixed in stationary states, always constitute significant resistance to the flowing of water, resulting in warp or cracking of the microbe carriers, lowering treatment efficacy and capacity. The microbe carriers placed in flowing states often collide with each other and have the biofilms thereof dropped away, resulting in significant reduction of treatment capability.

Similarly, in conventional processes of using particles to treat drain water, particles are also usually fixed in stationary states or placed in floating states, resulting in the same problem. FIGS. 13 and 14 (FIGS. 1 and 2 of U.S. Pat. No. 6,420,292) show some conventional examples of using particles to treat drain water, where drain water 4 (or another type of drain liquid) to be treated flows toward surfaces 1 of ceramic articles which were placed for the purpose of cleaning the drain water, and passes pores 2 to contact crystalline particles 3. FIG. 15 (FIG. 3 of U.S. Pat. No. 6,420,292) shows another conventional example of using particles to treat drain water, where drain water 4 (or another type of drain liquid) to be treated flows through three columns 6 connected in series and containing mixture 7 of porous ceramics therein for the purpose of cleaning the drain water. These conventional modes of using particles to treat drain water suffer the same problem.

It is thus seen that the application of either microbes or particles to the treatment of drain water (or another type of drain liquid) suffers problems to be solved and deserves improvement. Related industries have long been expecting better schemes for applying microbes to the treatment of drain water (or another type of drain liquid), by which need of alternation of facilities and need of inverse flowing process of cleaning can be eliminated, and simplification as well as convenience in treating drain fluid can be achieved. The present invention is therefore developed not only to provide solutions to the problems having long been faced by related industries, but also to further promote the efficiency and convenience in treating drain water or any fluid.

### SUMMARY OF THE INVENTION

It is an object of the present invention to provide an apparatus for related industries to apply microbes to the treatment of drain water (or another type of fluid).

It is another object of the present invention to provide an apparatus for related industries to reduce the cost of applying microbes to the treatment of drain water

It is a further object of the present invention to provide an apparatus for related industries to control the locations and distributions of microbe carriers in the drain water to be treated, for achieving better efficacy in treating drain water.

It is a object of the present invention to provide an apparatus for related industries to apply microbes to the treatment of drain water

It is another further object of the present invention to provide an apparatus for related industries to apply microbes to the treatment of drain water, by which microbe carriers can be conveniently replaced or supplemented or cleaned in an economic way.

It is furthermore another object of the present invention to provide an apparatus for related industries to apply microbes to the treatment of drain water, with which the storage facilities accommodating drain water can be conveniently and economically cleaned and subjected to maintenance.

One of the features of the present invention is that each module which contains some microbe carriers is used as an application or installation or operation or maintenance unit in treating drain water (or another type of fluid), and a plurality of the modules can be so fixed or supported to evenly disperse in the drain water to be treated, either in steady states or in states of moving in a certain region (a restricted region for example), thereby each of modules can be individually cleaned or replaced or relocated or subjected to maintenance.

One of the merits of the present invention is that a large mass of microbe carriers are distributed to a plurality of modules each can be used as an application or installation or operation or maintenance unit in treating drain water (or another type of fluid), not only for each of the modules to be individually used or installed or operated or subjected to maintenance, but also for any combination of the modules to be used or installed or operated or subjected to maintenance.

Another one of the merits of the present invention is that it is easy to adapt the installation, operation, and maintenance of microbe carriers to application environment/conditions and/or demands, as a result of the availability of application or installation or operation or maintenance units each containing only part of a large mass of microbe carriers.

A further one of the merits of the present invention is the significant promotion of efficacy and efficiency in treating drain water (or any fluid), resulting from easy control of the locations and/or distributions of a large mass of microbe carriers in application environment (inside of the drain water to be treated or on the surface surrounding the drain water to be treated, for example), because of the availability of installation or operation or maintenance units each containing only part of a large mass of microbe carriers.

Another further one of the merits of the present invention is the lower application cost and/or better immunization capability of microbe carriers against environmental influence, as a result of the convenience and simplification in acquiring, transporting, storing, inspecting, and auditing a large mass of microbe carriers, because of the availability of installation or operation or maintenance units each containing only part of a large mass of microbe carriers.

The other objects, features, and merits of the present invention may be comprehended from the following description with reference to drawings.

### INTRODUCTION TO THE INVENTION

One aspect of the present invention is an apparatus for treating a fluid, which comprises: at least a microbe carrier; and a container accommodating the microbe carrier, and including a restriction structure and a fluid passage structure, wherein the restriction structure is for restricting the moving of the microbe carrier so that the microbe carrier is either stationary or movable in a restricted region, the fluid passage structure provides a flow passage between the interior of the container and the exterior of the container, i.e., the fluid passage structure allows the fluid outside the container to flow into the container, and/or the fluid inside the container to flow out of the container, and/or the fluid passage structure allows the fluid to flow through the interior of the container (from one side of the container to another side of the container, for example). The fluid passage structure, for example, is such that the flow passage provided thereby includes at least one gap for the fluid to pass and contact at least part of the microbe carrier. The restriction structure, for example, is such that the microbe carrier is surrounded by at least part of it, and/or the gap is surrounded by part of it.

To provide better environment for microbes to reside and/or to be more effective, the microbe carrier according to the present invention, preferably, includes a plurality of holes.

The container according to the present invention, preferably further includes a force interface structure for receiving an external force applied thereto for controlling the location of the container and/or the moving of the container. Also preferably, the container further includes: a supporting interface structure for contacting an external object which is to support the container; and/or a connection interface structure for connecting the container and an external object to maintain a space between the container and the external object, or for connecting adjacent ones of the containers to maintain a space between the adjacent containers. The container may even further include: an entrance through which the microbe carrier is placed in the container, wherein an entrance-only structure is used for preventing the microbe carrier from moving to the outside of the container; and a lock structure controllable to be in one of two states, one allowing the microbe carrier to move outward from the container, the other preventing the microbe carrier from moving outward from the container.

The apparatus according to the present invention, preferably further comprises a supporter for supporting the container in such a way (in an adequate position, for example) that at least part of the microbe carrier therein contacts the fluid, or at least part of the container is submerged in the fluid. The supporter preferably includes a fixing portion and a connecting portion, the fixing portion being fixed by earth (ground, for example), the connecting portion for connecting the fixing portion and the container. The connecting portion may be a hardware by which the supporter supports the container in such a way that the container is fixed at a location or in a steady state. The connecting portion may otherwise be a software by which the supporter supports the container in such a way that the container moves in a restricted region. For example, the connecting portion may be a soft cord coupled, via the fixing portion (a fixing device, for example), onto a building or the facilities accommodating the fluid to be treated, or onto any external object.

Alternatively, the apparatus according to the present invention further comprises a swing driver for driving the container to swing, or a motion driver for driving the container to move, preferably, to move in a certain or restricted region.

The apparatus according to the present invention may further comprise a fluid-accommodation structure for accommodating the fluid to be treated, wherein the supporter is fixed onto the fluid-accommodation structure. For example, the supporter has a connecting portion thereof coupled or fixed, through a fixing portion thereof, onto the fluid-accommodation structure.

Another aspect of the present invention is an apparatus for treating a fluid which resides or is accommodated in a region surrounded by a fluid-accommodation structure. The apparatus comprises: at least a microbe carrier; a restriction structure for restricting the moving of the microbe carrier; and a supporter for supporting the restriction structure in such a way that at least part of the microbe carrier contacts the fluid. The restriction structure here, for example, is in the shape of a net enclosing the microbe carrier, thereby provides (or includes) a flow passage allowing fluid to flow therethrough while prevents the microbe carrier from moving therethrough. The flow passage includes a plurality of gaps through which at least part of the microbe carrier is contacted by the fluid. Furthermore, the restriction structure here is so configured as to separate a large mass of microbe carriers into a plurality of portions respectively residing in different regions, each of the portions movable only in one of the regions. The supporter here may include a fixing portion and a connecting portion, the fixing portion being coupled with (or fixed onto) the fluid-accommodation structure or earth or an external object (a building, for example) other than earth and the fluid-accommodation structure, the connecting portion for connecting the fixing portion and the restriction structure. For example, the fixing portion is a hardware bar or connected with the fluid-accommodation structure, the connecting portion is a software or hardware material connecting the fixing portion and the restriction structure. Alternatively the fixing portion may be a component for fixing one end of the connecting portion (a bar or a cord) onto the fluid-accommodation structure or a building.

To maintain a better efficacy in treating the fluid surrounded by the fluid-accommodation structure fluid, the apparatus here preferably includes a space-maintaining structure for maintaining a space between the microbe carrier and the fluid-accommodation structure, or maintaining a space between two portions (particularly adjacent ones) of the mass of microbe carriers used in treating the fluid. For example, the space-maintaining structure is a bar between the restriction structure and the fluid-accommodation structure, or a bar between different parts of the restriction structure wherein different parts of the restriction structure restrict the moving of different portions of the mass of microbe carriers used to treat the fluid.

A further aspect of the present invention is a method for treating a fluid. The method comprises: accommodating at least a microbe carrier by a container, the container restricting the moving of the microbe carrier and allowing the fluid to flow between the interior thereof and the exterior thereof; and supporting the container in such a way that at least part of the microbe carrier contacts the fluid.

The present invention may best be understood through the following description with reference to the accompanying drawings, in which:

### BRIEF DESCRIPTION OF THE DRAWINGS

FIGS. 1-4 show embodiments of apparatus provided according to the present invention.

FIG. 5 shows a top view of an embodiment of the apparatus shown in FIGS. 1-2.

FIG. 6 shows an embodiment of connecting a plurality of the apparatus shown in FIGS. 1-5.

FIGS. 7-8 show another embodiments of apparatus provided according to the present invention.

FIGS. 9-10 show another further embodiments of apparatus provided according to the present invention and based on the embodiments represented by FIGS. 1-5 or FIG. 6 or FIGS. 7-8.

FIG. 11 is a side view of the apparatus shown in FIG. 10.

FIGS. 12a-12b show a still further embodiment of apparatus provided according to the present invention and based on the embodiments represented by FIGS. 1-5 or FIG. 6 or FIGS. 7-8.

FIGS. 13-14 show prior arts (FIGS. 1 and 2 of U.S. Pat. No. 6,420,292).

FIG. 15 shows a prior art (FIG. 3 of U.S. Pat. No. 6,420,292).

### DETAILED DESCRIPTION OF THE PREFERRED EMBODIMENTS

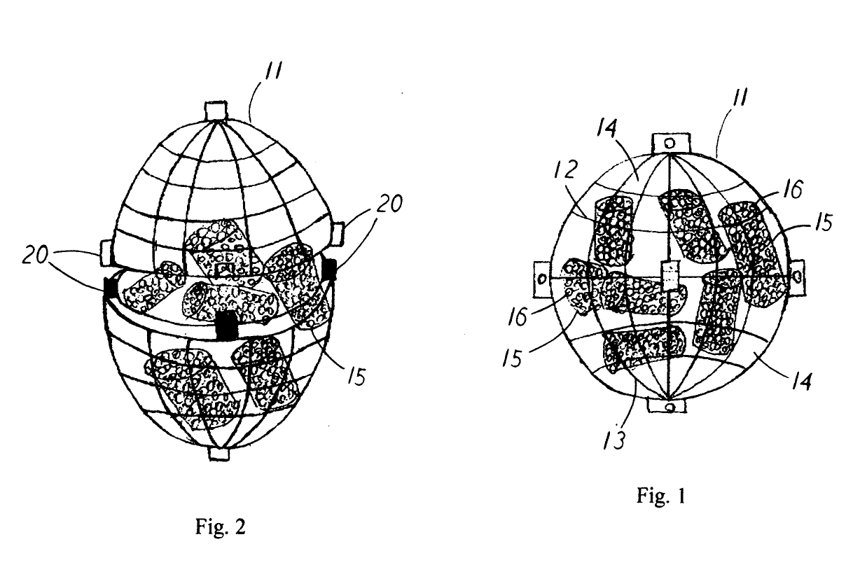

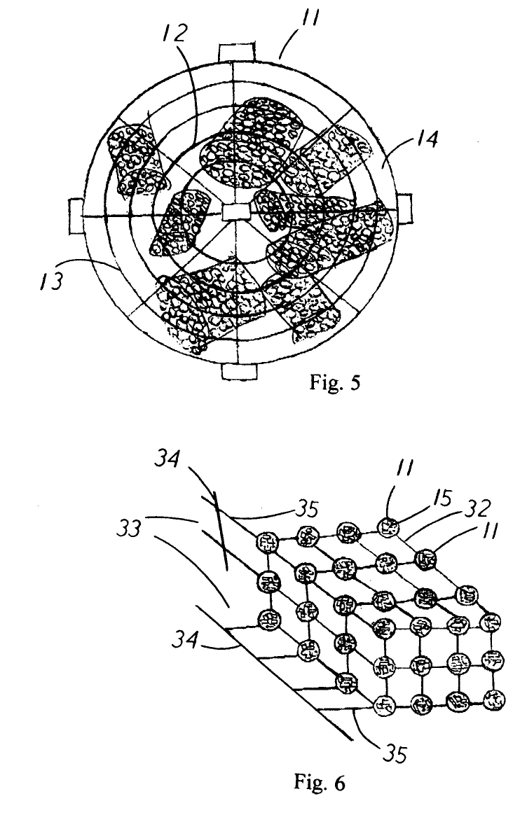

Embodiments of the apparatus provided according to the present invention for treating a fluid are now illustrated by referring to the side views shown in FIGS. 1, 2, 3, and 4, and the top view shown in FIG. 5. In FIGS. 1, 2, 3, 4, and 5, at least a microbe carrier 15 is accommodated in a container 11, container 11 includes a restriction structure composed of (or represented by) plural bars 12 and 13, container 11 also includes a fluid passage structure composed of (or represented by) a plurality of gaps 14 which are defined (or surrounded) by bars 12 and 13, the restriction structure composed of plural bars 12 and 13 is for restricting the moving of the microbe carrier 15 so that the microbe carrier 15 is either stationary or movable in a restricted region such as the interior of container 11, the fluid passage structure represented by the plurality of gaps 14 provides a flow passage between the interior of the container 11 and the exterior of the container 11, i.e., the fluid passage structure represented by the plurality of gaps 14 allows the fluid (not shown in FIG. 1) outside the container 11 to flow into the container 11, and/or the fluid inside the container 11 to flow out of the container 11, and/or the fluid passage structure represented by the plurality of gaps 14 allows the fluid to flow through the interior of the container 11 (from one side of the container 11 to another side of the container 11, for example). The fluid passage structure represented by the plurality of gaps 14, obviously, allows fluid to pass and contact part or the whole of microbe carrier 15. The restriction structure composed of plural bars 12 and 13, for example, is in the shape of a net enclosing the interior of container 11, and defining the plurality of gaps 14, wherein each of the gaps 14 is such that microbe carrier 15 cannot pass therethrough to move out of container 11. Gap 14, for example, may have size smaller than microbe carrier 15 or be so shaped as to prevent microbe carrier 15 from passing therethrough.

To provide better environment for microbes to reside and/or to be more effective, the microbe carrier 15 according to the present invention, preferably, includes a plurality of holes 16.

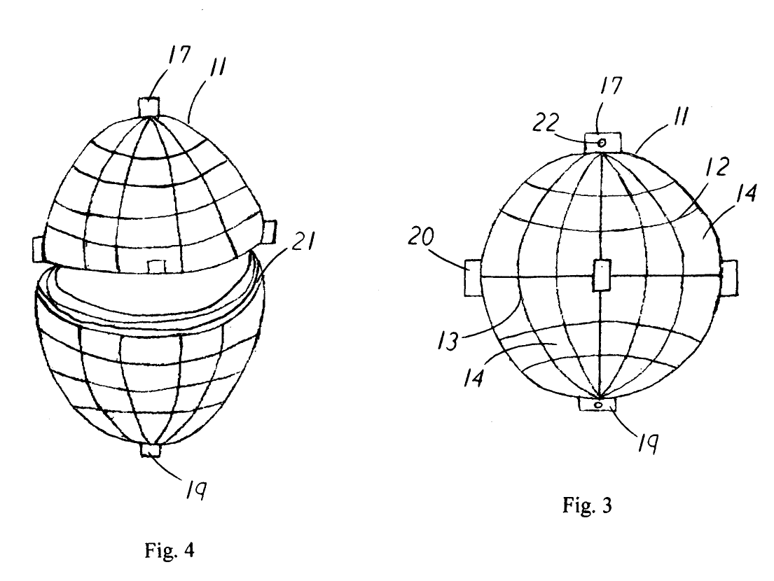

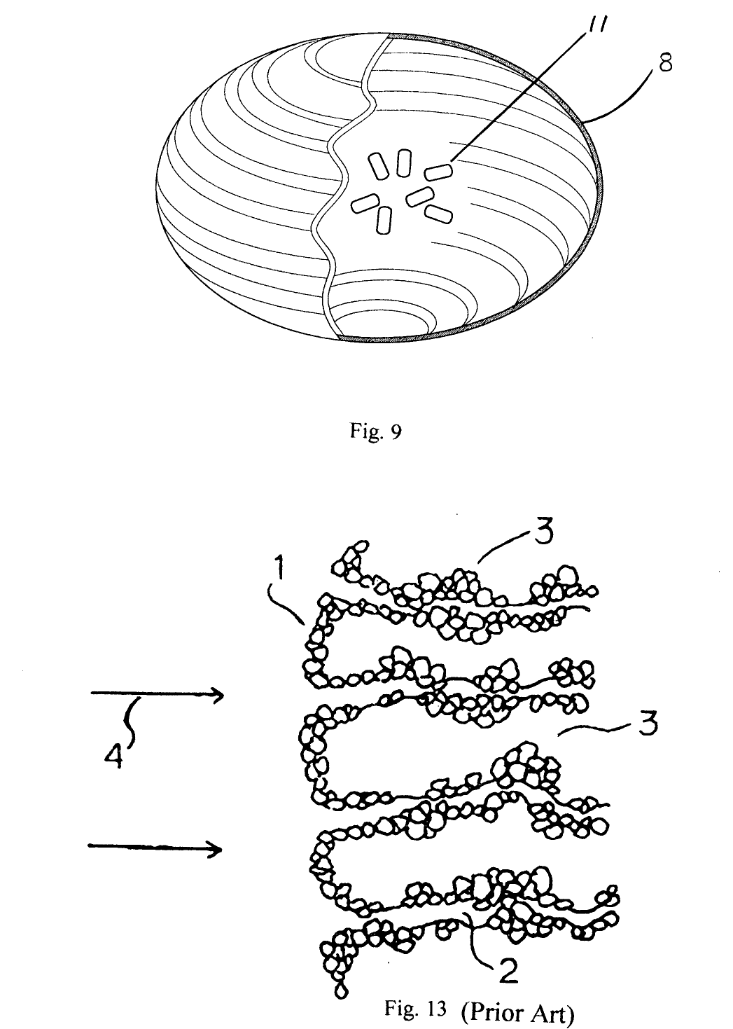

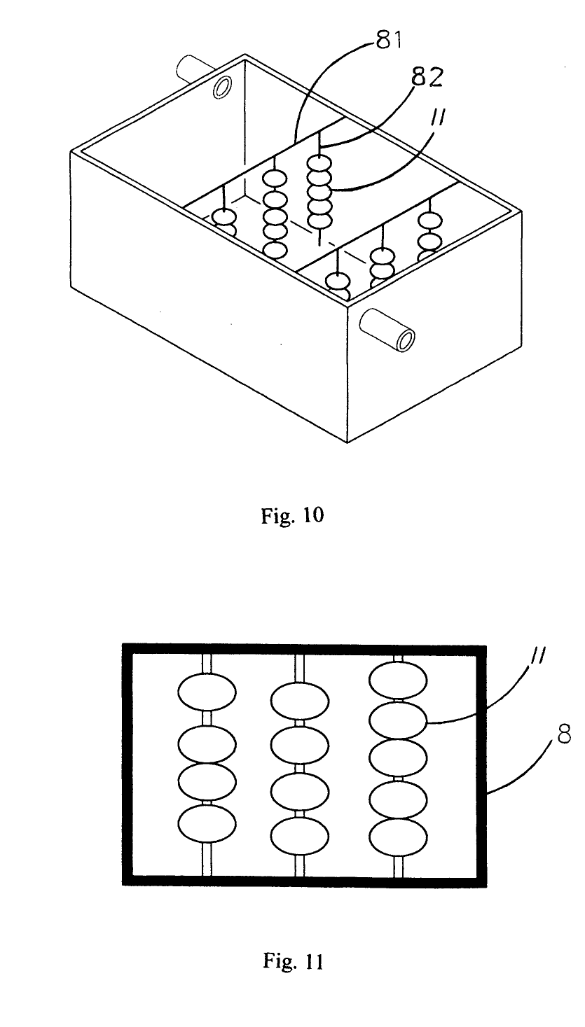

The container 11 according to the present invention, preferably further includes a force interface structure 17 (in FIGS. 3 and 4) for receiving an external force applied thereto for controlling the location of the container 11 and/or the moving of the container 11. Also preferably, the container 11 further includes: a supporting interface structure 19 (in FIGS. 3 and 4) for contacting an external object (such as a bar 82 fixed via bar 81 onto a fluid-accommodation structure 8 in FIG. 10) which is to support the container 11; and/or a lock structure 20 (in FIGS. 2 and 3) which is controllable to be in one of two states, one allowing the restriction structure (composed of plural bars 12 and 13) to be separated into two parts for microbe carrier 15 to move outward from (and/or inward to) the container 11, the other keeping the restriction structure (composed of plural bars 12 and 13) to enclose the interior of container 11 thereby preventing the microbe carrier 15 from moving outward from the container 11. Lock structure 20 may be replaced by an entrance (not shown in figures) through which the microbe carrier 15 is placed in the container 11, wherein an entrance-only structure (not shown in figures) is used for preventing the microbe carrier 15 from moving to the outside of the container 11 through the entrance. The entrance-only structure, for example, may include at least a bendable (or flexible) and thin object having one end fixed on the edge of the entrance, and having another end movable and pointing to the interior of container 11 to allow microbe carrier 15 to move from the exterior of container 11 to the interior of container 11, but prevent microbe carrier 15 from moving out of the interior of container 11. Either the force interface structure 17 or supporting interface structure 19 can also be used as a connection interface structure for connecting the container 11 and an external object (such as the fluid-accommodation structure 8 shown in FIG. 9 or objects 81 and 82 fixed onto the fluid-accommodation structure 8 shown in FIG. 10) to maintain a space between the container 11 and the external object, or for connecting a space-maintaining structure 32 (in FIG. 6) between adjacent ones of a plurality of containers 11 to maintain a space between the adjacent containers 11. Space-maintaining structure 32 in FIG. 6 may also be used to connect container 11 and an external object (not shown in figures).

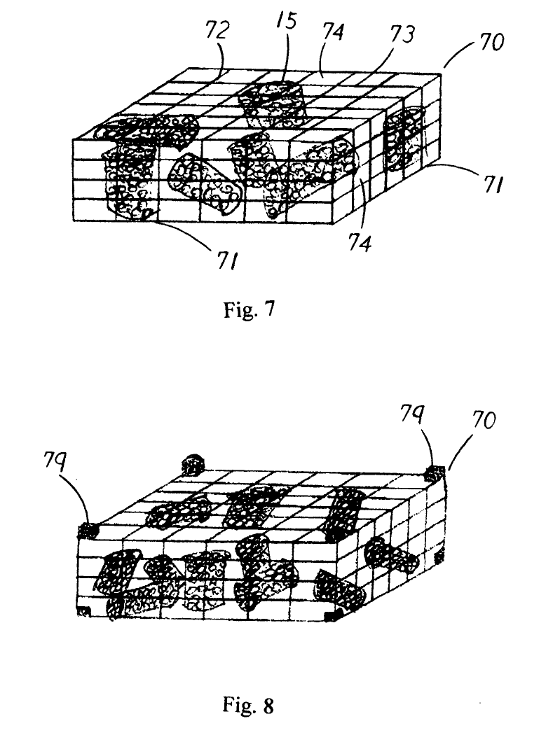

The apparatus according to the present invention, preferably further comprises a supporter 33 (in FIG. 6) for supporting the container 11 in such a way (in an adequate position, for example) that at least part of the microbe carrier 15 in container 11 contacts the fluid (not shown in figures), or at least part of the container 11 is submerged in the fluid (not shown in figures). The supporter 33 preferably includes a fixing portion 34 and a connecting portion 35, the fixing portion 34 being fixed onto earth (not shown in figures) or an external object such as a building (not shown in figures) or a fluid-accommodation structure accommodating the fluid to be treated, the connecting portion 35 for connecting the fixing portion 34 and the container 11. The connecting portion 35 may be a hardware by which the supporter 33 supports the container 11 in such a way that the container 11 is fixed at a location (not shown in figures) or in a steady state. The connecting portion 35 may otherwise be a software by which the supporter 33 supports the container 11 in such a way that the container 11 is movable in a restricted region (not shown in figures). For example, the connecting portion 35 may be a soft cord coupled, via fixing portion 34, onto a building (not shown in figures) or the facilities (not shown in figures) accommodating the fluid to be treated, or onto any external object. Fixing portion 34 is not always necessary for coupling connecting portion 35 onto an external object. Connecting portion 35 may be directly coupled onto an external object such as a building or the facilities (not shown in figures) accommodating the fluid to be treated. Alternatively the fixing portion may be just a component for fixing one end of the connecting portion (a bar or a cord) onto the fluid-accommodation structure or a building, thereby another end of the connecting portion moves or swings with containers 11 connected thereto. Another embodiments of the apparatus provided according to the present invention are represented by FIGS. 7 and 8. In FIG. 7, the apparatus 70 provided according to the present invention includes: a restriction structure defining a plurality of gaps 74 and being composed of plural bars 72 and 73; a plurality of microbe carriers 15 enclosed by the restriction structure; and a supporter 71 for supporting the apparatus 70. The apparatus provided according to the present invention and represented by FIG. 7 preferably further includes a structure 79 (in FIG. 8) which can be used as a force interface structure or a supporting interface structure or a connection interface structure. The structure 79, for example, may be used to connect apparatus 70 and an external object (not shown in figures), for maintaining a space between apparatus 70 and the external object. As a plurality of apparatus 70 are often used to treat a fluid accommodated in the same facilities, structure 79 may also be used to directly connect two adjacent apparatus 70 or connect two adjacent apparatus 70 via a space-maintaining structure (corresponding to the space-maintaining structure 32 shown in FIG. 6), for maintaining a space between two adjacent apparatus 70.

An application of the apparatus 70 (shown in FIGS. 7 and 8) to the treatment of a fluid is that a plurality of the apparatus 70 are placed in a fluid-accommodation structure (such as the one indicated by 8 in FIGS. 9, and 10), with structure 79 connected to the fluid-accommodation structure directly or via a space-maintaining structure or via a supporter (corresponding to the supporter composed of objects 81 and 82 shown in FIGS. 10 and 11). Supporter 71 (shown in FIG. 7) may be between apparatus 70 and the bottom of the fluid-accommodation structure to support apparatus 70. Alternatively another object such as the supporter (shown in FIG. 10) composed of objects 81 and 82 and fixed onto the fluid-accommodation structure may be used to support apparatus 70 in such a way that apparatus 70 is in a steady position or moves in a restricted region, with microbe carriers 15 enclosed therein contacting the fluid to be treated.

FIGS. 9, and 10 show an apparatus provided according to the present invention for treating a fluid, which comprises: a fluid-accommodation structure 8 for accommodating the fluid (not shown in figures) to be treated; a plurality of containers 11 accommodating microbe carriers 15 (not shown in FIGS. 9 and 10, but shown in FIGS. 1, 2, 6, and 7) and being installed in the fluid-accommodation structure 8; and a supporter composed of objects 81 and 82, for supporting containers 11, with object 81 fixed onto the fluid-accommodation structure 8, with object 82 connecting object 81 and a series of containers 11. FIG. 11 is a side view of the apparatus shown in FIG. 10. In FIG. 10, for example, object 81 of the supporter is used as a fixing portion coupled or fixed onto the fluid-accommodation structure 8, and object 82 of the supporter is used as a connecting portion coupled to the fixing portion (object 81) to support a series of containers 11. All the microbe carriers accommodated in containers 11, preferably, have at least part thereof contacting the fluid (not shown in figures) which is to be treated and which is in the region surrounded or defined by the fluid-accommodation structure 8.

The object 82 in FIG. 10 may be a hardware by which the supporter composed of objects 81 and 82 supports the container 11 in such a way that the container 11 is fixed at a location (not shown in figures) or in a steady state. The object 82 may otherwise be a software by which the supporter composed of objects 81 and 82 supports the container 11 in such a way that the container 11 is movable in a restricted region (not shown in figures).

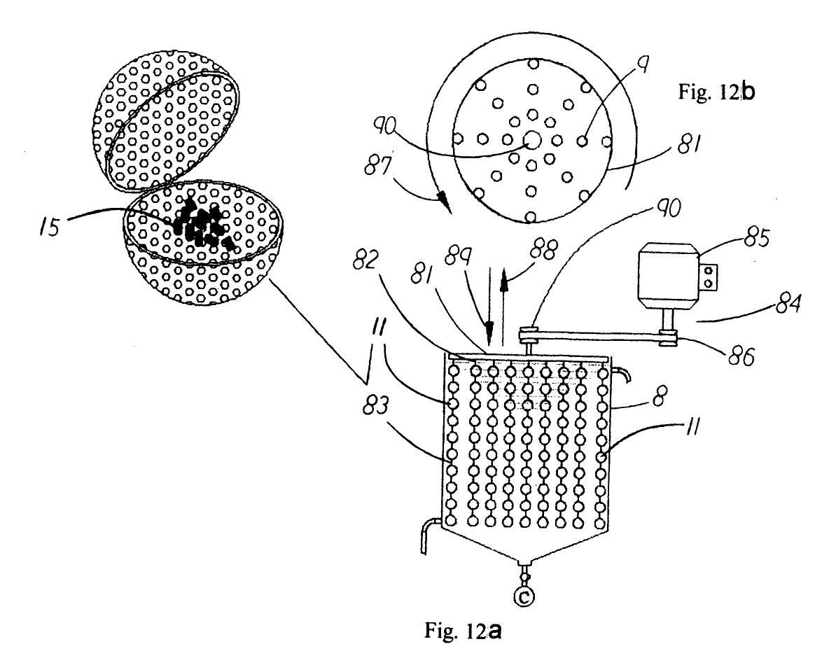

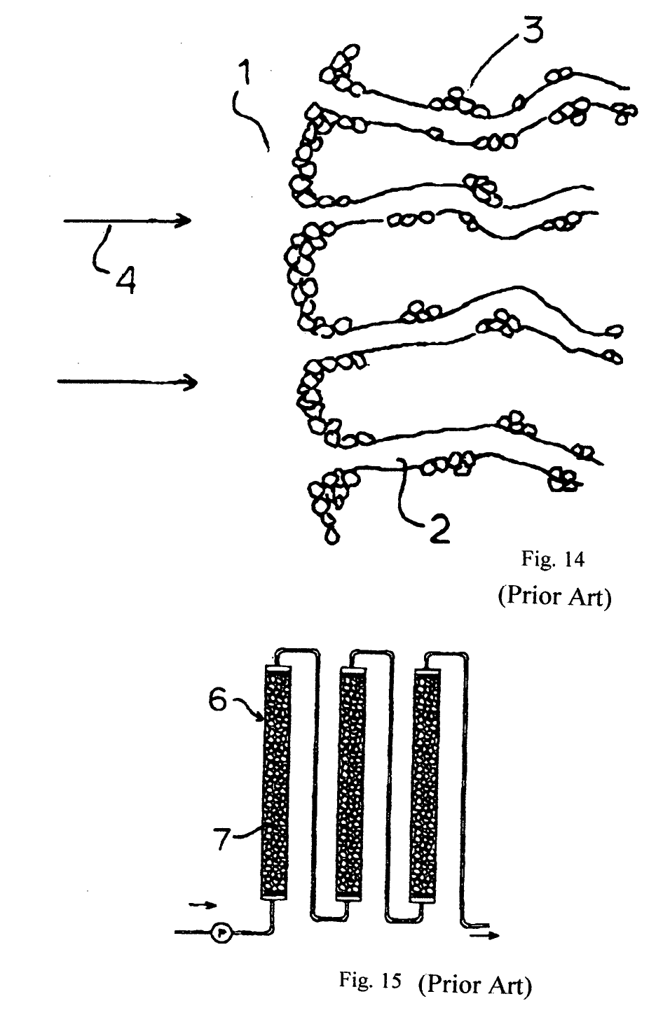

Another further embodiment of an apparatus provided according to the present invention is shown in FIGS. 12a (side view) and 12b (top view). In FIG. 12a, a fluid-accommodation structure 8 is used to accommodate a fluid (not shown in figures) to be treated, a plurality of containers 11 are supported by a supporter composed of connecting portions 82 and a fixing portion 81, the plurality of containers 11 are separated into many groups each with containers 11 therein connected and spaced by a space-maintaining structure 83, each container 11 has at least a microbe carrier 15 therein, fixing portion 81 is coupled to a motion or swing driver 84 composed of a motor 85 (or any motion power producer), a motion transmitter 86, and a motion transmission interface 90. Containers 11 move or swing in response to the operation of driver 84. An example of driving containers 11 to swing up and down is indicated by arrows 88 (upward) and 89 (downward) in FIG. 12a, another example of driving containers 11 to move is indicated by an arrow 87 (rotate around the center of fluid-accommodation structure 8 seen from the top of fluid-accommodation structure 8) in FIG. 12b. Obviously containers 11 may also be driven to rotate in an inverse direction, or to swing in clockwise and counter clockwise directions seen from the top of fluid-accommodation structure 8. The apparatus is preferably such that each of the containers 11 installed in fluid-accommodation structure 8 has the microbe carrier therein contacted by the fluid (not shown in figures) accommodated in fluid-accommodation structure 8.

Still another further embodiment of the present invention is a method for treating a fluid, which comprises: accommodating at least a microbe carrier 15 by a container (11 in FIGS. 1 and 2, or apparatus 70 in FIGS. 7 and 8), the container restricting the moving of the microbe carrier 15 and allowing the fluid (not shown in figures) to flow between the interior thereof and the exterior thereof; and supporting the container (11 in FIGS. 1 and 2, or 70 in FIGS. 7 and 8) in such a way that at least part of the microbe carrier 15 accommodated by container 11 contacts the fluid.

While the invention has been described in terms of what are presently considered to be the most practical and preferred embodiments, it shall be understood that the invention is not limited to the disclosed embodiment. On the contrary, any modifications or similar arrangements shall be deemed covered by the spirit of the present invention.

What is claimed is:

1. An apparatus for treating a fluid, comprising:
at least a microbe carrier; and
a container accommodating said microbe carrier, and including a restriction structure and a fluid passage structure, said restriction structure for restricting the moving of said microbe carrier, said fluid passage structure providing a flow passage between the interior of said container and the exterior of said container.

2. The apparatus according to claim 1 wherein said microbe carrier includes a plurality of holes.

3. The apparatus according to claim 1 wherein said microbe carrier is surrounded by said restriction structure.

4. The apparatus according to claim 1 wherein said flow passage includes at least a gap for said fluid to pass and contact at least part of said microbe carrier.

5. The apparatus according to claim 1 wherein said flow passage includes at least a gap defined by said restriction structure.

6. The apparatus according to claim 1 wherein said container further includes a force interface structure for receiving an external force applied thereto.

7. The apparatus according to claim 1 wherein said container further includes a force interface structure for receiving an external force applied to control at least one selected from among the location of said container and the moving of said container.

8. The apparatus according to claim 1 wherein said container further includes a supporting interface structure for contacting an external object.

9. The apparatus according to claim 1 wherein said container further includes a connection interface structure for connecting said container and an external object to maintain a space between said container and said external object.

10. The apparatus according to claim 1 wherein said container further includes an entrance through which said microbe carrier is placed in said container.

11. The apparatus according to claim 10 wherein said container further includes an entrance-only structure for preventing said microbe carrier from moving to the outside of said container.

12. The apparatus according to claim 1 wherein said container further includes a lock structure controllable to be in one of two states, one allowing said microbe carrier to move outward from said container, the other preventing said microbe carrier from moving outward from said container.

13. The apparatus according to claim 1 wherein said fluid passage structure allows said fluid to flow through the interior of said container.

14. The apparatus according to claim 1 further comprising a supporter for supporting said container in such a way that at least part of said microbe carrier contacts said fluid.

15. The apparatus according to claim 1 further comprising a supporter for supporting said container in such a way that at least part of said container is submerged in said fluid.

16. The apparatus according to claim 14 wherein said supporter including a fixing portion and a connecting portion, said fixing portion being fixed onto one selected from among earth and an external object, said connecting portion for connecting said fixing portion and said container.

17. The apparatus according to claim 14 wherein said connecting portion is a hardware, thereby said supporter supports said container in such a way that said container is stationary.

18. The apparatus according to claim 14 wherein said connecting portion is a software, thereby said supporter supports said container in such a way that said container is movable in a restricted region.

19. The apparatus according to claim 1 further comprising a swing driver for driving said container to swing.

20. The apparatus according to claim 1 further comprising a motion driver for driving said container to move.

21. The apparatus according to claim 1 further comprising: a fluid-accommodation structure for said fluid to reside; and a supporter for supporting said container in such a way that at least part of said microbe carrier contacts said fluid, said supporter being fixed onto said fluid-accommodation structure.

22. The apparatus according to claim 21 wherein said supporter includes a fixing portion and a connecting portion, said connection portion being coupled onto said fluid-accommodation structure via said fixing portion.

23. An apparatus for treating a fluid which is accommodated in a region surrounded by a fluid-accommodation structure, comprising:
at least a microbe carrier;
a restriction structure for restricting the moving of said microbe carrier; and
a supporter for supporting said restriction structure in such a way that at least part of said microbe carrier contacts said fluid.

24. The apparatus according to claim 23 wherein said supporter includes a fixing portion and a connecting portion, said fixing portion being coupled with said fluid-accommodation structure, said connecting portion for connecting said fixing portion and said restriction structure.

25. The apparatus according to claim 23 wherein said supporter includes a fixing portion and a connecting portion, said fixing portion being fixed onto at least one selected from among earth, said fluid-accommodation structure, and an external object other than earth and said fluid-accommodation structure.

26. The apparatus according to claim 23 further includes a space-maintaining structure for maintaining a space between said microbe carrier and said fluid-accommodation structure.

27. The apparatus according to claim 23 further includes a space-maintaining structure for maintaining a space between different ones of said restriction structures.

28. The apparatus according to claim 23 wherein said restriction structure includes a flow passage.

29. The apparatus according to claim 28 wherein said flow passage includes at least a gap for said fluid to contact at least part of said microbe carrier.

30. A method for treating a fluid, comprising:
accommodating at least a microbe carrier by a container, said container restricting the moving of said microbe carrier and allowing said fluid to flow between the interior thereof and the exterior thereof; and
supporting said container in such a way that at least part of said microbe carrier contacts said fluid.
